(19) United States
(12) Patent Application Publication
(10) Pub. No.: US 2017/0303570 A1
(43) Pub. Date: Oct. 26, 2017

(54) METHODS OF PREPARING MEAT PRODUCTS AND MEAT PRODUCTS THEREFROM

(71) Applicant: David Cohen, Toronto (CA)

(72) Inventor: David Cohen, Toronto (CA)

(21) Appl. No.: 15/486,337

(22) Filed: Apr. 13, 2017

Related U.S. Application Data
(60) Provisional application No. 62/325,467, filed on Apr. 21, 2016.

(51) Int. Cl. A23L 13/60; A23B 4/03; A23B 4/06

(52) U.S. Cl. CPC A23L 13/67; A23B 4/06; A23B 4/03; A23V 2002/00

(57) ABSTRACT

The present invention provides methods for preparing hygienic dried meat products and biltong hygienic dried meat products, the method includes cutting uncooked meat into uncooked meat slices, immersing said meat slices in a vinegar solution for up to twenty minutes to form soaked meat slices, air drying the soaked meat slices for less than 72 hours to form the biltong hygienic dried meat product having at least 100,000 fold less microbes than the uncooked meat.

### REFERENCE TO RELATED APPLICATIONS

This application relates to and claims the priority benefit of U.S. provisional application 62/325,467, filed on Apr. 21, 2016.

### FIELD OF THE INVENTION

The present invention relates generally to methods for preparing meat products, and more specifically to methods for preparing uncooked meat products.

### BACKGROUND OF THE INVENTION

Throughout the centuries, man has developed many different methods for preserving food products. Meat products are difficult to preserve safely without cooling, refrigeration or freezing.

“Biltong” is a Dutch name given to a variety of dried, cured meat, which originated in South Africa. Many different types of meat may be used in the preparation of Biltong, such as beef, game meats, ostrich fillets and the like. Typically, Biltong is prepared by cutting raw fillets of meat into strips, following the grain of the muscle, or flat pieces sliced across the grain. It is similar to beef jerky in that they are both spiced, dried meats. The typical ingredients, taste and production processes differ, the main difference being that biltong is sliced and then hung and dried. Typical production times are around a fortnight.

U.S. Pat. No. 6,383,549 B1 relates to a food snack comprising light, crispy wafers of dried minced food, typically dried minced meat and a process for making the food snack. The process includes the steps of dicing and mincing the food, feeding the food into a sausage casing, freezing the food in the casing, cutting the food into slices and drying the slices.

Chinese patent no. CN 103330236 A describes a new high-fat (30-50%) biltong product and preparation method thereof. Their disclosed biltong comprises pork, duck, fish meat, salt 4-7%, white sugar, gourmet powder, and other ingredients. Their process includes a short heating stage (1-2 minutes immersion in boiling water) followed by placing in the soil for 18-20 minutes. The invention further discloses a preparation method of the biltong; the preparation method comprises the following steps: selecting material, cleaning, dis-acidifying, sterilizing, adding condiment, and smudging. The biltong provided by the invention not only can conform to an eating habit of Chinese, but also can meet requirements of appearance, nutrition and safety of export to meat product, and meanwhile, the preparation method of the biltong is not limited by seasons, environment and temperature, so that industrialized and large-scale industrial production can be formed.

There thus remains a need to provide safe and time-efficient methods for preparing cured meat products.

### SUMMARY OF THE INVENTION

It is an object of some aspects of the present invention to provide safe methods for preparing cured meat products.

It is another object of some aspects of the present invention to provide reduced-time methods for preparing cured meat products.

In some embodiments of the present invention, improved methods and cured products are provided for animal consumption.

In some embodiments of the present invention, improved methods and cured products are provided, fit for human consumption.

The present invention provides methods for preparing hygienic dried meat products and biltong hygienic dried meat products, the method comprising cutting uncooked meat into uncooked meat slices, immersing said meat slices in a vinegar solution for up to twenty minutes to form soaked meat slices, air drying the soaked meat slices for less than seventy two hours to form the biltong hygienic dried meat product having at least 100,000 fold less microbes than the uncooked meat.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more details than is necessary for a fundamental understanding of the invention, the description taken with the drawings making apparent to those skilled in the art how the several forms of the invention may be embodied in practice.

In the drawings:

FIG. 1 is a simplified flow chart of a method for preparing a meat product, in accordance with an embodiment of the present invention.

FIG. 2 is a simplified flow chart of a method for preparing a meat product from a mixture of minced or emulsified meat with other ingredients, in accordance with an embodiment of the present invention.

### DETAILED DESCRIPTION OF THE INVENTION

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

### Raw Material Handling and Storing

The raw materials may include one or more of:

a. Duck

b. Water Buffalo

c. Lamb

d. Beef

e. Kangaroo

f. Other type of animal meat

Meat can be processed either fresh or frozen and in the form of solid meat, ground meat, or emulsified meat.

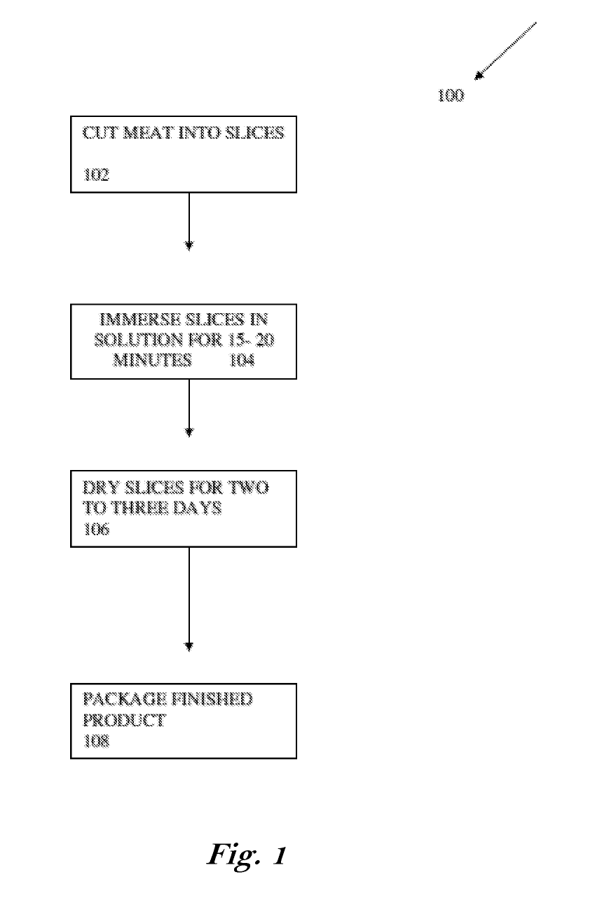

Reference is now made to FIG. 1, which is a simplified flow chart 100 of a method for preparing a meat product from solid meat, in accordance with an embodiment of the present invention.

In a first cutting step 102, a meat product is cut into slices.

When processing any of the meat (called herein “materials”) any exterior vacuum seal bags and any other packaging that the material is delivered in are removed.

When processing any of the beef, buffalo, kangaroo and or lamb, most or all of the skin, fat, sinew, cartilage, veins, bones and any other tissue that is not muscle meat is removed and disposed of. This should preferably leave only muscle meat, but at the same time one should exercise best efforts to reduce any loss or waste of actual muscle meat during the cleaning process. Alternatively, some fat tissue can be left without being removed pre-drying. In this case, the final outcome of the drying process may depend on the type of animal meat. For example, beef fat will likely solidify under room temperature while lamb fat will likely remain liquefied or semi-liquefied under room temperature. A person skilled in the art should be able to determine how much fat to be left on the animal meat pre-drying depending on the meat type and desired outcome.

Thereafter, in cutting step 102, the muscle meat is cut into steak slices. According to some embodiments, these are thin slices. According to one embodiment, the slices are no thicker or thinner than (three eights) 0.375 inches or (nine and a half) 9.525 millimeters with an allowable tolerance of 2% plus or minus.

According to another embodiment the slices are from (¼) inches or 0.635 centimeters thick up to three eights (⅜) of an inch or 0.952 centimeters with an allowable tolerance of no more than 2% plus or minus.

### Duck Breast and Tenderloin

Duck will either arrive as duck breast with or without skin or duck tenderloin.

If received as duck tenderloin, no cleaning or further cutting is necessary as the desired sizes are already satisfied.

If the duck arrives as duck breast the breast may or may not contain skin, if the breast contains skin then the skin and any sinew or fat is removed from the breast.

The breast is then sliced in half lengthwise (butterfly) effectively creating two breasts.

Thereafter, in cutting step 102, the muscle meat is cut into steaks slices.

According to some embodiments, these are thin slices. According to one embodiment, the slices are no thicker or thinner than 0.564 inches or 14.32 millimeters with an allowable tolerance of 2% plus or minus.

When processing kangaroo meat or other types of meat that arrive in the form of trim (trim is considered to be off cuts that are typically collected and packaged as bulk in 5-25 kilo bags or boxes), the meat must be frozen and then cut into steak slices that are no thicker or thinner than (three eights) 0.375 inches or (nine point five two five) 9.525 millimeters with an allowable tolerance of 2% plus or minus.

In an immersing step 104, the cut slices are immersed in an aqueous solution. According to some embodiments, the aqueous solution is an acidic solution.

According to some further embodiments, the aqueous solution is a vinegar solution.

According to some further embodiments, the aqueous solution is a 5% acid vinegar solution. The vinegar solution may be any commercially available vinegar solution, such as apple cider vinegar, wine vinegar, malt vinegar, other types of vinegar, acetic acid solution and combinations thereof.

According to some further embodiments, the aqueous solution is a 5% apple cider vinegar solution. The apple cider is selected for its taste, smell, and nutritional value. However, other types of vinegar can be used.

According to some further embodiments, once all of the meat is sliced or reduced down to size, then it is treated with only apple cider vinegar which is no less than a 5% acidity level.

There is provided enough apple cider vinegar to cover all of the meat leaving no meat exposed to the outside elements, where the meat is completely submerged underneath the vinegar.

The vinegar is discarded after one use. Each batch of meat requires a new batch of vinegar further insuring that the acidity level is maintained at no more or less than 5%.

The meat slices are immersed for at least ten minutes, at least fifteen minutes, at least 18 minutes or up to twenty minutes. The meat slices should not be removed from the vinegar for any time before 15 minutes have passed and should not be left to soak in the vinegar for more than 20 minutes. Soaking the slices for more than twenty minutes may leave a residual smell therein.

The soaked slices are then dried in a drying step 106. Various options may be used for drying, including hanging laying to dry, air drying, sun drying or combinations thereof.

For example, the soaked slices may be placed on a stainless steel baking sheet with holes punctured in the baking sheet allowing enough air flow to reach at least 95% of the meat. Alternatively, the soaked slices may be hung individually on meat hooks. Each piece of meat shall not touch another and shall maintain enough space between each piece where there is enough space for proper airflow to pass between each individual piece.

Once the soaked meat has properly been hung or placed on a baking sheet or rack the meat shall be placed in a room where the temperature shall be maintained at within a temperature range of 28-45 degrees Celsius, or preferably 28-33 degrees Celsius. The humidity moisture level to be maintained under 40%, preferably, in the range of 25-35%, or more preferably, in the range of 30%-35% humidity.

The meat slices are left undisturbed under these drying conditions for no less than 40 hours and no more than 75 hours. More preferably, the drying time should be between 48-60 hours. After the time period has elapsed the meat slices are removed from the room and shall not be reintroduced into any temperature less than room temperature. The dried sliced meat is now considered to be a finished product, ready for packaging.

The dried product is tested in quality control for water activity, pH and bacterial count. The water activity in three different samples was found to be in the range of 0.45-0.70. The pH was found to be in the range of 5.0-5.5. The E. coli, Listeria monocytogenes and Salmonella counts were all zero (negative). The term “hygienic” herein is used to denote a product devoid of bacterial contamination.

The protein percent was found to be in the range of 65-85%. The fat content was found to be in the range of 3-25% and the moisture content (forced oven) was found to be in the range of 5-16% (all on a weight/weight basis).

In the case of minced meat the fat content may, according to some embodiments, be greater. For example, the protein percent may be in the range of 40-85% and the fat content may be in the range of 5-60%. Thus, the minced meat product may have a higher calorific value than the non-minced meat product. For example, the minced meat product may have a calorific value in the range of 4000-6000 Kcal/kg, whereas the non-minced meat product typically has a calorific value of 3000-5000 Kcal/kg.

In a packaging step, 108, the dried sliced meat is packaged. In some cases, the dried sliced meat is removed off the baking sheets and/or the meat hooks using a pair of stainless talons. Optionally, using other cutting tools, the dried sliced meat is further cut down the product into pieces that are no smaller than 1 inch wide by 1 inch in length and no larger than 2 inches wide by 2 inches in length. According to other embodiments, the pieces are at least 2 inches wide by 2 inches in length and no larger than 3 inches wide by 3 inches in length. And in other cases, the meat pieces are further cut down to smaller pieces, for example, to 9 mm slices to be used as bites for training small and older dogs. And yet in other cases, the meat pieces are further ground down to granules or particles to be used in applications such as cat treats.

All finished products shall not be reintroduced or come in to contact with raw meat or materials or tools that are or where used in the manufacturing of raw meat unless the materials or tools have been completely disinfected and now appear dry.

The cut down products shall then be packaged in each of its respective bags.

Kangaroo shall only be packaged in bags with the kangaroo label affixed to it.

Buffalo shall only be packaged in bags with the buffalo label affixed to it.

Beef shall only be packaged in bags with the beef label affixed to it.

Duck shall only be packaged in bags with the duck label affixed to it.

Lamb shall only be packaged in bags with the lamb label affixed to it.

Further, different packaging bags may be used to package the meat with different cuts or different product lines.

With an allowable tolerance of no more than 3.5%, the dried slice meat product is filled into bags, with products based on the weight located on the label on the upper right hand corner (“weight”). For example a 60 gram packaging cannot be filled with less than 60 grams of product however a 60 gram bag can be filled over the amount stated but not to exceed an allowable overage of 3.5% therefore not to exceed 62.1 grams of product on a 60 gram packaging.

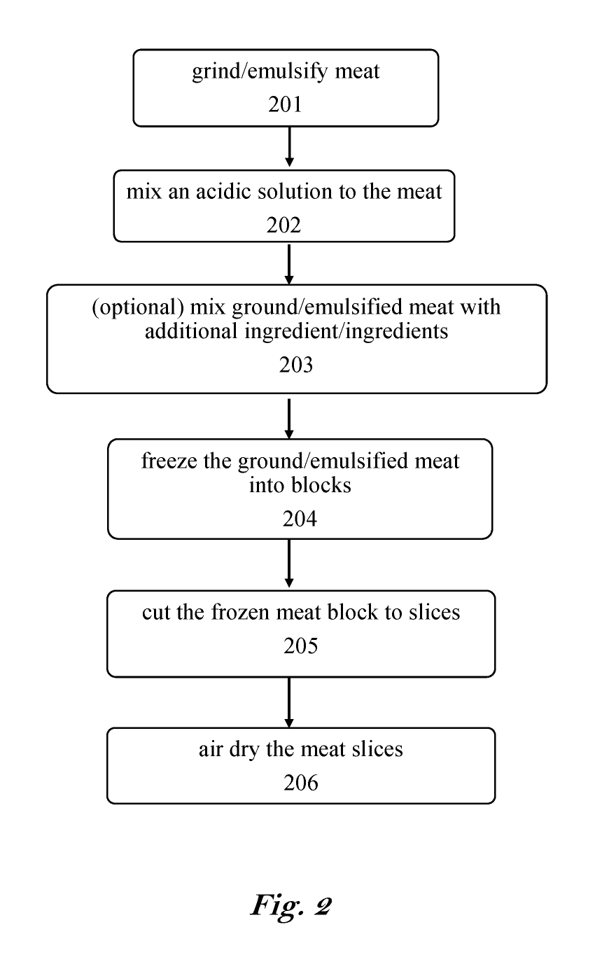

In the event that the meat is processed as ground or emulsified, additional steps are taken to prepared the meat as shown in FIG. 2. First, uncooked meat is ground, emulsified, or similarly processed to ground meat or meat pulp (201), then the meat is optionally mixed with any desired ingredients (202), including spices, seasonings, vegetables, cheese, other desirable additives or combinations of additives. Once the mix recipe is satisfactory, then an acidic solution is added to the mixture (203). The amount of acidic solution is below 30% by weight in the final mixture. In one embodiment, an apple cider vinegar of 5% acidity is added below 20% by weight. Then the mixture is frozen to blocks (204). The frozen blocks of meat or meat mixture then are processed including cutting to slices (205) and drying the slices(206) similar to the process with solid animal meat.

### Further Packaging

Oxygen Absorbers:

According to some embodiments, the purchaser shall deliver oxygen absorbers, each box contains 75 bags and each bag contains 20 absorbers, this combination shall vary depending on what combination the supplier sends to the purchaser.

The absorbers have a limited shelf life once the bag is open and the absorbers are exposed to the air.

Sealing:

Each package is sealed individually with a seal bar using an impulse sealer or a heat sealer, the location of the seal is across the top of the packaging directly above a zipper of the packaging and underneath of the hanging hole, and the manufacturer will make sure each packaging is properly sealed.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

What is claimed is:

1. A method for preparing a hygienic dried meat product, the method comprising:
a. cutting uncooked meat into uncooked meat slices;
b. immersing said meat slices in a acidic solution for up to twenty minutes to form soaked meat slices;
c. air drying said soaked meat slices for less than 72 hours to form said hygienic dried meat product.

2. The method according to claim 1, wherein said hygienic dried meat product is biltong.

3. The method according to claim 1, wherein said hygienic dried meat product is for animal consumption.

4. The method according to claim 1, wherein said hygienic dried meat product is for human consumption.

5. The method according to claim 1, further comprising:
d. packaging said hygienic dried meat product.

6. The method according to claim 1, wherein said slices are of a thickness below ¾ inch.

7. The method according to claim 1, wherein said immersing step is immersing in a vinegar solution of 5% in acidity for 15 to 20 minutes.

8. The method according to claim 7, wherein said vinegar solution is an apple cider vinegar solution of 5% in acidity.

9. The method according to claim 1, wherein said air drying step is for 48-60 hours.

10. The method according to claim 9, wherein said air drying step is performed in a temperature range of 26-40 degrees Celsius.

11. The method according to claim 10, wherein said air drying step is performed in a temperature range of 28-33 degrees Celsius.

12. The method according to claim 1, wherein said air drying step is performed in an air humidity range of 18-30%.

13. The method according to claim 1, wherein said air drying step is performed by hanging said soaked meat slices.

14. The method according to claim 1, wherein said air drying step is performed by placing said soaked meat slices on perforated trays through which air is provided.

15. The method according to claim 1, wherein said uncooked meat is selected from beef, duck, kangaroo, lamb and buffalo.

16. The method according to claim 5, wherein said packaging step further comprises, cutting said hygienic dried meat product into pieces of a length of less than three inches.

17. The method according to claim , wherein said packaging step further comprises, placing said hygienic dried meat product in vacuum sealable packaging.

18. A biltong hygienic dried meat product, produced according to the method of claim 1.

19. A method for preparing a hygienic dried meat product, the method comprising:
a. grinding or mechanically emulsify uncooked meat to ground meat or meat pulp;
b. mixing an acidic solution to the ground meat or meat pulp;
c. freezing the ground meat or meat pulp to frozen meat blocks;
d. cutting the frozen meat blocks into frozen meat slices;
e. air drying said meat slices for less than 72 hours to form said hygienic dried meat product.

20. A hygienic dried meat product, produced according to the method of claim 19.

21. A method for preparing a hygienic dried meat product, the method comprising:
a. grinding or mechanically emulsify uncooked meat to ground meat or meat pulp;
b. mixing an acidic solution to the ground meat or meat pulp;
c. mixing the ground meat or meat pulp with seasoning and spices to form ground meat mixture or meat pulp mixture;
d. freezing the ground meat mixture or meat pulp mixture to frozen meat blocks;
e cutting the frozen meat blocks into frozen meat slices;
f. air drying said frozen meat slices for less than 72 hours to form said hygienic dried meat product.

22. A hygienic dried meat product, produced according to the method of claim 21.
